(19) United States
(12) Patent Application Publication
(10) Pub. No.: US 2013/0144700 A1
(43) Pub. Date: Jun. 6, 2013

(54) Promotion Processing

(71) Applicant: First Data Corporation, Atlanta, GA (US)

(72) Inventors: Theodore VanDeburg, Denver, CO (US); Dania J. Ruiz-Paramo, Greenwood Village, CO (US); Catherine C. Marasigan, Littleton, CO (US); Kevin Knowles, Highlands Ranch, CO (US)

(73) Assignee: FIRST DATA CORPORATION, Atlanta, GA (US)

(21) Appl. No.: 13/690,810

(22) Filed: Nov. 30, 2012

Related U.S. Application Data
(60) Provisional application No. 61/566,298, filed on Dec. 2, 2011.

(51) Int. Cl. G06Q 30/02

(52) U.S. Cl. CPC G06Q 30/0225
USPC 705/14.23

(57) ABSTRACT

Methods, systems, computer executable instructions, and devices for processing promotions and prepaid accounts are provided. In one exemplary embodiment, a method includes providing a unique identifier associated with a promotion to a customer and associating the unique identifier with a promotion code in a database. The method also includes the step of receiving the unique identifier from a merchant, where the customer provided the unique identifier to the merchant in order to redeem the promotion in a transaction. Finally, the method includes retrieving the promotion code from the database based on the received unique identifier, and transmitting the promotion code for delivery to the merchant.

### RELATED APPLICATIONS

This application claims priority to U.S. Provisional Patent Application No. 61/566,298, entitled “PROMOTION PROCESSING,” which was filed on Dec. 2, 2011, the contents of which is incorporated by reference in its entirety.

### TECHNICAL FIELD

Various embodiments of the present application generally relate to the field of computer-based transaction processing. More specifically, various embodiments of the present application relate to methods and systems for processing promotional offers.

### BACKGROUND

Many types of promotions and discount offers are used by merchants in order to increase customer traffic for their business, increase familiarity with their products or services, increase exposure of their products or services, reward loyal customers, and/or increase sales. In many cases, promotions are operated in the form of a coupon which a customer provides to a merchant in order to get the benefit associated with the promotion. In other cases, the customer must provide some other type of promotion code or documentation in order to redeem a promotion. Promotions may be configured in many formats including a fixed percentage discount, a discounted price on a specific product, buy one get one free, a free item or service, a credit for a fixed amount, or other formats. While these various types of promotions may accomplish the intended objectives of the merchant, they also sometimes lead to reductions in profit margin and even to losses on particular transactions in some cases. While this tradeoff may be acceptable to the merchant for particular transactions or for a designated number of transactions, the merchant may also want to control how these promotions are used and redeemed in order to better control or limit the potential downsides associated with these types of programs.

In some cases, coupons or promotion codes are duplicated and repeatedly reused by customers. A single customer may attempt to reuse a promotion code that was only intended to be used once and/or may distribute that promotion code such that others can use it as well. While reuse may be acceptable in some situations, merchants often want to distribute promotions with more control over how they are redeemed. The reuse problem can become even more significant in electronic transaction environments such as the Internet. Many promotion codes are distributed in the form of a promotion number, promotion code, or other type of code which is manually entered by a customer in an electronic transaction. In these cases, promotion codes may be subject to widespread duplication over the Internet.

In addition to wanting to control the number of times a particular instance of a promotion or a coupon may be used, merchants may also want to have better control over the types of transactions which are eligible for the promotions, the customers who are eligible to redeem them, and how the redemption process is managed across multiple geographic locations. In addition to reducing financial risks, improved control over promotion processing may also yield more detailed usage data which can be used for marketing purposes.

### SUMMARY

Methods, systems, computer executable instructions, and devices for processing promotions are provided. In one embodiment, a method includes associating a plurality of unique identifiers with a promotion in a database. The method further includes receiving at least one of the unique identifiers from a merchant system operated by a merchant, where the at least one unique identifier was provided by a customer to the merchant in order to redeem the promotion in a transaction. The method further includes retrieving promotion information from the database based on the received unique identifier and validating the received unique identifier. Finally, the method includes transmitting a transaction instruction for delivery to the merchant system.

In one variation of the method described above, the merchant system is a point of sale (POS) system.

In another variation of the methods described above, the transaction instruction includes a discount code used by a merchant's POS system to adjust an amount of the transaction.

In yet another variation of the methods described here, the received unique identifier is documented in a database.

In some cases, validating the received unique identifier includes determining that the received unique identifier has not already been used a maximum permitted number of times.

In some cases, the methods described here may include receiving transaction information identifying a product or a service included in the transaction. Validating the received unique identifier may then include determining, based on the received transaction information and the retrieved promotion information, that the product or the service satisfies a requirement of the promotion. The transaction information may identify the product or the service using a stock-keeping unit (SKU) of the product or the service. Determining that the product or the service satisfies the requirement of the promotion may include determining that the SKU is included in a list of acceptable SKUs for the promotion.

In another variation of the methods disclosed here, validating the received unique identifier may include transmitting a product requirement associated with the promotion to a merchant and receiving an indication from the merchant that the product requirement is satisfied. In some cases, the product requirement includes one or more product SKUs that will satisfy the promotion.

In a further variation of the disclosed methods, validating the received unique identifier includes determining that a time requirement associated with the promotion is satisfied. The time requirement may include an expiration date of the promotion, a window of time in which the promotion is valid, or one or more days of the week in which the promotion is valid.

In another variation of the methods described here, determining that the time requirement associated with the promotion is satisfied may include using a current time associated with a location of the merchant system.

The methods disclosed here may include receiving a customer identifier associated with the customer such that validating the received unique identifier includes determining, using the customer identifier, that the customer is eligible to redeem the promotion.

In some cases, the customer identifier may be an identifier of an account used by the customer to pay for the transaction. In other cases, the unique identifier may be a prepaid account identifier.

Any of the methods, including combinations, may be implemented in the form of a system comprising a processor, a database, and a memory. The methods may also be implemented in the form of a non-transitory computer-readable medium including computer-executable instructions that direct at least one computer processor to implement the various steps described above.

While multiple embodiments are disclosed, still other embodiments of the present invention will become apparent to those skilled in the art from the following detailed description and figures, which show and describe illustrative embodiments of the invention. As will be realized, the invention is capable of modifications in various aspects, all without departing from the scope of the present invention. Accordingly, the drawings and detailed description are to be regarded as illustrative in nature and not restrictive or limiting.

### BRIEF DESCRIPTION OF THE DRAWINGS

Embodiments of the present invention will be described and explained through the use of the accompanying figures.

FIG. 1 illustrates an example of an operating environment in which some of the techniques disclosed herein may be used.

FIG. 2 illustrates a method of processing a promotion in accordance with some of the disclosed techniques.

FIG. 3 illustrates an operating environment in which some of the disclosed techniques may be used.

FIG. 4 illustrates processing of a promotion in accordance with some of the disclosed techniques.

FIG. 5 illustrates a computing system for processing promotions.

FIG. 6 illustrates a method of processing a promotion at a merchant in accordance with some of the disclosed techniques.

FIG. 7 illustrates a method of processing a promotion using a prepaid account.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments or implementations described. On the contrary, the invention is intended to cover all modifications, equivalents, and alternatives falling within the scope of the invention as defined by the appended claims.

### DETAILED DESCRIPTION

Various techniques discussed in the present application relate to the field of processing promotions for products and/or services. Many of the examples discussed herein are described from the perspective of a credit/debit/prepaid card processing system, server, or entity. The intention, however, is not to limit the invention to implementation by a credit/debit/prepaid card processor. On the contrary, the invention is intended to cover all implementations falling within the scope of the invention as defined by the appended claims. In the following description, for the purposes of explanation, numerous specific details are set forth in order to provide a thorough understanding of embodiments of the present invention. It will be apparent, however, to one skilled in the art that embodiments of the present invention may be practiced without some of these specific details.

In some embodiments, a payment transaction processor may be in a position to process product promotions and prepaid accounts in manners which give merchants additional control over how these promotions tools are used. For instance, merchants or marketing entities, such as advertisers, often provide coupons, promotion codes, or vouchers for discounts on products or services. These coupons are sometimes offered in a printed form and are sometimes offered in a virtual or electronic form. The merchant is often interested in controlling the number of times each promotion can be redeemed. Unfortunately, conventional methods of providing these discounts are often susceptible to duplication of the coupons, vouchers, or codes. Discounts are often used repeatedly by one or more customers and sometimes widely distributed through the Internet. Some websites are dedicated to distributing coupon or discount codes which have been provided to others. A merchant who originally intended to offer a promotion to a limited number of customers, possibly even to specific customers in a targeted manner, may end up giving the discount a much larger number of times due to sharing and distribution of the coupon or discount code. For example, a discount code intended for a small number of loyal customers of an online merchant could be posted online and used by thousands of customers resulting in significant and unexpected loss of profit for the merchant.

The techniques disclosed herein provide a solution to the problems discussed above by providing a unique identifier for each instance of the promotion, coupon, or discount code which is created or distributed. Each unique instance of the coupon, promotion, or discount code can only be used once, or a controlled number of times in some cases. Once used the permitted number of times, the coupon, promotion, or discount code cannot be used again even if shared or copied. Because a merchant's POS system may not be sophisticated enough to manage the unique identifiers or the merchant may be unable to track them across multiple geographic locations, the unique identifiers are processed and managed by a transaction processor. When a customer attempts to use the coupon, promotion, or discount code at a merchant, the merchant sends the unique identifier to the transaction processor to verify that this instance of the promotion has not already been used, redeemed, or deactivated for some other reason. Existing methods of managing use of prepaid cards and gift cards may also be well suited for implementing the techniques disclosed herein for processing promotions. In some cases, a card having a unique account number like a prepaid card, but having a zero value, may be distributed as a promotion or coupon.

In some cases, merchants may be interested in providing discounts or promotions that provide discounts, credit, or “cash” towards a purchase of specific products or categories of products. The merchant may distribute a coupon or promotional material which states this type of product restriction. However, this approach is typically dependent upon an employee or system of the merchant to recognize and enforce the product restriction associated with the credit or promotion. It would be beneficial for merchants to have a system of implementing product specific discounts which is centralized, more easily controlled, and more reliably implemented. It is also beneficial for merchants if the steps that must be performed by their employees in promotion redemption processes can be reduced or eliminated. It may also be beneficial to process promotions in a manner such that the employees do not have access to the codes that ultimately trigger the POS to apply the associated discounts or credits.

In some cases, a card transaction processor may be in a position to use prepaid accounts to solve the problems described above. The promotion or discount may be offered in the form of a prepaid account or prepaid card. When created, the prepaid account is associated with a product or category of products in a centralized database. When the prepaid account is redeemed by the customer, the prepaid account and information about the product it is being used for are sent to the card transaction processor. The card transaction processor is able to verify that the product is a product or category of product for which the promotion was originally intended. If so, an amount of the prepaid account is applied to reduce the purchase price of the product. This approach not only allows the merchant to control which products a discount will be used on but allows each instance of the discount or promotion to be used only once as previously described.

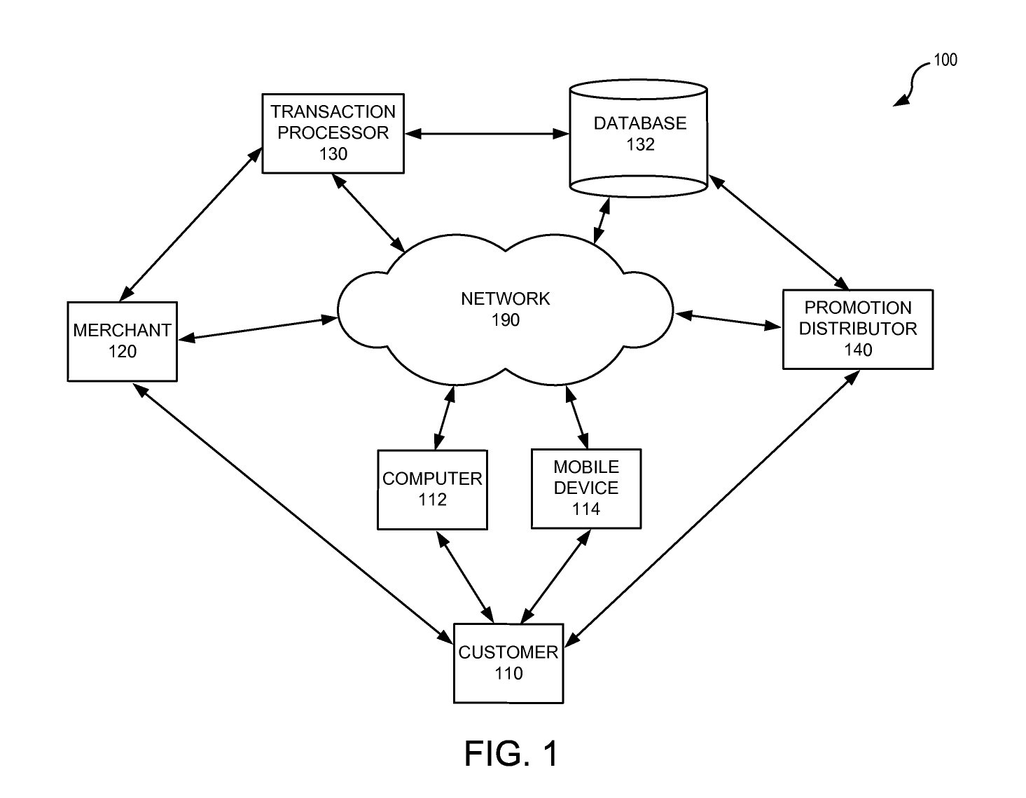

Having described embodiments of the present invention generally, attention is directed to FIG. 1 which illustrates operating environment 100 in which some embodiments of the present invention may be utilized. Operating environment 100 includes customer 110, computer 112, mobile device 114, merchant 120, transaction processor 130, database 132, promotion distributor 140, and network 190.

Customer 110 is any party who may be targeted for or receive a promotion or discount offer for a product or service offered by merchant 120. Merchant 120 is any provider of goods or services. Customer 110 may engage in transactions directly with merchant 120 or by using computer 112 or mobile device 114, either of which may communicate with merchant 120 or other entities through network 190. Computer 112 and mobile device 114 may each be any type of computing mechanism or electronic device which enables customer 110 to enter data to make a purchase or perform another type of financial transaction. Computer 112 may be a personal computer, server, Internet terminal, kiosk, set top box, or computing device of another type. Mobile device 114 may be a wireless phone, smartphone, wireless computer, personal digital assistant (PDA), tablet, or transportable computing device. Computer 112 and mobile device 114 may operationally connect to network 190 through wired or wireless means.

Transaction processor 130 is any entity or system which facilitates the processing of financial transactions. Transaction processor 130 may be a credit card processor, a debit card processor, a bank, a lender, an account verification service, or other entity which handles processing of payments made by customer 110 for products or services. Communications between merchant 120 and transaction processor 130 may occur through a direct connection or may occur through network 190, another network, or a combination of networks.

In order to implement one or more of the techniques disclosed herein, transaction processor 130 retrieves promotion and/or account information from database 132 and documents transaction information in database 132. Database 132 may be any type of data storage system. The components of database 132 may include a disk drive, optical disk, flash memory, solid state memory, tape drive, or other device for storing digital data, including combinations thereof. Database 132 may be made up of multiple devices or systems that are spread across multiple geographic locations. Transaction processor 130 may store information in database 132 relating to discounts, promotions, offers, credit accounts, prepaid accounts, transactions, or other business activities, including combinations thereof.

Promotion distributor 140 may implement and/or distribute offers or promotions for merchant 120. These promotions may be distributed to customer 110 directly, through merchant 120, or through other means. When a promotion or discount is created, information is stored in database 132 relating to the promotion. This information is accessed by transaction processor 130 when the promotion or discount is redeemed. Promotion distributor 140 and/or the functions of promotion distributor 140 may be implemented by transaction processor 130, by merchant 120, or by another entity.

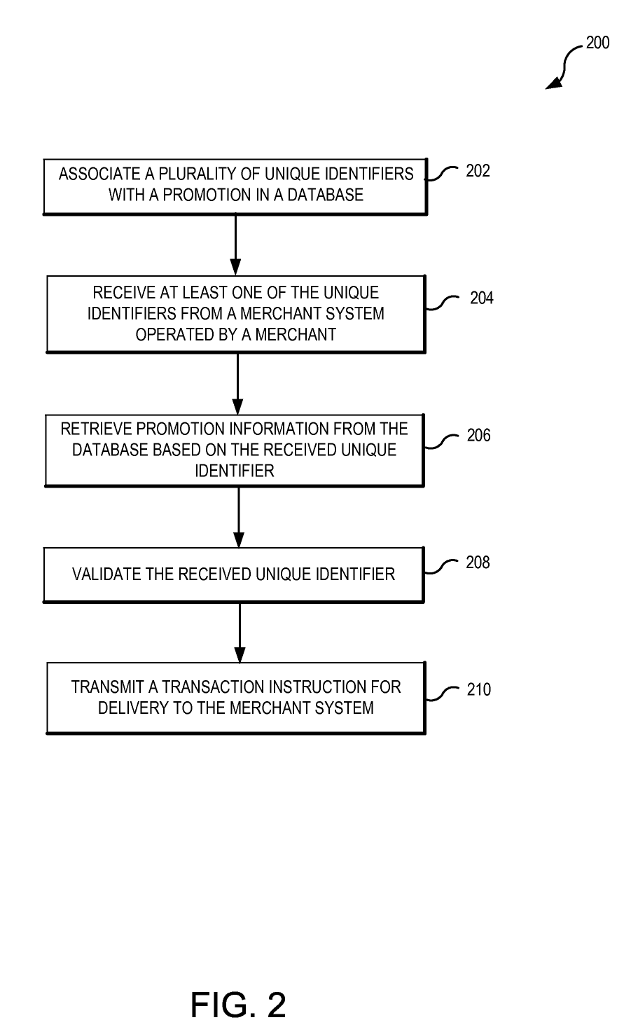

FIG. 2 illustrates computer-implemented method 200 of processing promotions which may be used in an exemplary embodiment of the invention. Method 200 is described with respect to operating environment 100 of FIG. 1 although method 200 may be implemented in other operating environments or systems.

In step 202 of method 200, unique identifiers are associated with a promotion in database 132. The promotion is associated with merchant 120 and/or a product or a service of merchant 120. Each of the unique identifiers may include one or more of a number, a letter, a code, a barcode, a quick response (QR) code, a universal resource locator (URL), or other information, including combinations thereof, that allows the identifiers, or groups of the identifiers to be individually identified. The unique identifiers may be distributed to customers, including customer 110, in many ways including: a paper coupon, a mailer, a magazine advertisement, a newspaper advertisement, the Internet, a web page, an email, a text message, a magnetic strip, a radio frequency identification (RFID) tag, television advertising, radio advertising, or an electronic message. The unique identifiers may be provided to customers in conjunction with information describing the promotion or may be separately provided to or accessed by the customers. The unique identifiers may be provided by promotion distributor 140, merchant 120, transaction processor 130, or another entity such as a parent, corporate, or partner entity associated with merchant 120.

Information about the promotion and information about the unique identifier(s) are stored in database 132. The information about the promotion stored in database 132 may include a description of the promotion, a processing code associated with the promotion, a set of rules and requirements associated with the promotion, a list of merchants at which the promotion is valid, and/or other information associated with the promotion such as time periods in which the promotion is valid. The information about the unique identifiers may include a list of each of the individual unique identifiers, the promotion(s) with which each of the identifiers is associated, a number of times each of the identifiers may be used or redeemed, specific customer(s) which may redeem the identifier, one or more merchants at which the identifier may be used, and/or other information about the use of the identifier such as information about one or more transactions in which it has been used.

Advantageously, a specific number of unique identifiers may be associated with any individual promotion. For example, merchant 120 may work with promotion distributor 140 to create 50 instances of a particular discount for a product or a service of merchant 120. The unique identifiers are distributed to customer 110 and other customers in a targeted fashion. The unique identifiers are recorded in database 132 and associated with the promotion such that redemption of each of the individual instance of the promotion can be tracked and/or verified. The information about the promotion and the information about the unique identifiers may be stored in database 132 and interrelated using known database methods. The information may be stored in the database by promotion distributor 140, transaction processor 130, merchant 120, or another entity, including combinations thereof.

Customer 110 may use the unique identifier to redeem the promotion in a number of different ways. For example, customer 110 may visit merchant 120 in person, conduct a transaction in person, and physically provide the unique identifier to merchant 120 in the form of a paper coupon or other written documentation. Customer 110 may also conduct a transaction with merchant 120 over network 190, or another network, using an electronic device such as computer 112 or mobile device 114. Alternately, customer 110 may provide the unique identifier to merchant 120 electronically even though conducting the transaction in person, such as with a mobile communication device. In other cases, customer 110 may also conduct a transaction with merchant 120 using another form of communication, such as voice communication using a telephone. Using one or more of these methods, the unique identifier is received into a system of the merchant. Either the customer or the merchant may perform steps to input the unique identifier into the merchant system. In some cases, the unique identifier may be input into the merchant system using manual entry techniques. In some cases, the merchant system is a POS system used by the merchant to conduct transactions with customers. Once the unique identifier is received by the merchant system, it is transmitted to transaction processor 130.

Continuing with method 200, transaction processor 130 receives at least one of the unique identifiers from the merchant system operated by merchant 120 at step 204. The unique identifier may be received through a direct communication with the merchant system or using one or more networks such as network 190. The unique identifier may be received by transaction processor 130 in conjunction with another message, such as a payment authorization request for a credit card or a debit card, or it may be received separately from other communications. At step 206, transaction processor 130 retrieves previously stored promotion information associated with the unique identifier from database 132 using the received unique identifier.

At step 208, transaction processor 130 validates the unique identifier for use to redeem the promotion. Validating the unique identifier may include performing a number of different steps that are described in detail in the examples which follow. At step 210, transaction processor 130 transmits a transaction instruction for delivery to merchant 120 or a merchant system operated by merchant 120. The transaction instruction may be any type of information or code used by the merchant system to apply the promotion to the transaction being conducted between customer 110 and merchant 120.

In one example, a promotion is a 30% discount on a single purchase and merchant 120 wants 1000 unique instances of this promotion to be made available to customers. Unique identifiers or codes are generated and associated with each of the 1000 instances of the promotion. The unique identifiers associated with the 1000 instances of the promotion are stored in database 132 and associated with information about the promotion including any rules or requirements associated with the promotion. The transaction instruction that is transmitted to merchant 120 after a unique identifier is received and validated contains information instructing a transaction system of the merchant to apply the 30% discount to the transaction. In some cases, the merchant system may be a POS system and the transaction instruction may be a code that instructs the POS to apply the 30% discount. In some cases, merchant 120, or an employee of merchant 120, may not have visibility or access to the code when it is received by the merchant system and applied to the transaction. In this way, potential reuse or distribution of the code can be further reduced. In some cases, the code may be a code which can only be received and applied electronically by the POS and cannot be entered manually by an employee or by customer 110.

In conjunction with validating the unique identifier, transaction processor 130 may also document usage of the unique identifier in database 132. This may be accomplished by storing information in database 132 indicating that the unique identifier was used to redeem a promotion or by deleting the unique identifier from a list of valid unique identifiers for the promotion. In this way, the unique identifier will not be validated or approved if there is a subsequent attempt to reuse the unique identifier by customer 110 or another party. If the unique identifier is not validated or approved by transaction processor 130, the transaction instruction which triggers the discount will not be sent to the merchant system and no discount will be applied for the transaction. In some cases, a transaction instruction indicating that the promotion could not be validated or was denied may be sent to the merchant system if that particular unique identifier has already been redeemed or cannot be validated for some other reason.

In some cases, the unique identifier may be valid for multiple uses, but not an unlimited number of uses. For example, a unique coupon code provided to customer 110 may be valid for three uses. Each use is documented in database 132, even in cases where the redemptions occur at different physical locations of merchant 120. Upon on each attempted use, the information in database 132 is accessed to determine if there are any uses remaining. Once that instance of the promotion (i.e., that unique identifier) has been used three times, subsequent requests (i.e., a fourth request) will not be validated or approved.

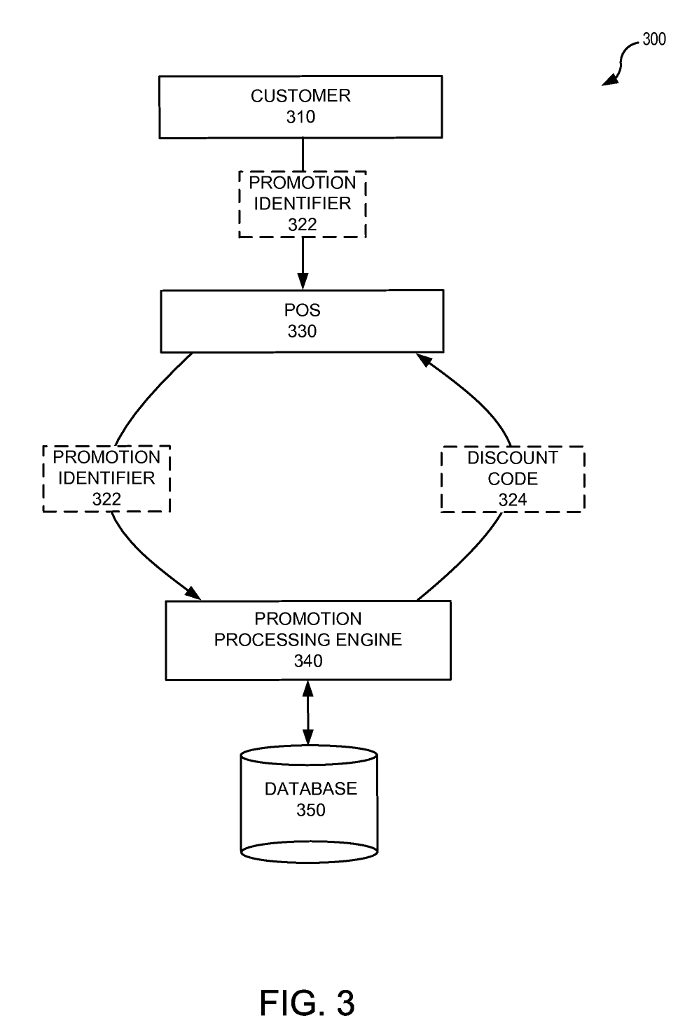

FIG. 3 illustrates operating environment 300 in which some of the disclosed techniques may be used. Operating environment 300 includes customer 310, POS 330, promotion processing engine 340, and database 350. Customer 310 is an example of customer 110 of FIG. 1. POS 330 is any type of transaction processing system used by a merchant, such as merchant 120, to perform financial transactions. Database 350 is an example of database 132 of FIG. 1. Promotion processing engine 340 is any computing device, or group of computing devices, configured to validate promotion identifiers. In some cases, promotion processing engine 340 is operated by, or on behalf of, a transaction processor such as transaction processor 130.

In one example, customer 310 provides promotion identifier 322 to POS 330 in conjunction with a transaction. Promotion identifier 322 is associated with a promotion and includes information that allows it to be uniquely identified from among other identifiers associated with the same promotion such that its use can be individually identified and/or controlled. Promotion identifier 322 may be communicated from customer 310 to POS 330 in a number of ways including swiping a card with a magnetic strip, scanning a barcode, entering a code, providing a code in printed form, transmitting data electronically, or through a combination of these methods. Promotion identifier 322 may be input into POS 330 by customer 310 or by an operator of POS 330. In some cases, promotion identifier 322 may be provided to a merchant and entered into POS 330 by the merchant. Promotion identifier 322 may be also be transmitted to POS 330 through a network, such as the Internet.

After receiving promotion identifier 322, POS 330 then transmits it to promotion processing engine 340. Promotion identifier 322 may be transmitted to promotion processing engine 340 alone or in conjunction with other information about customer 310 or the associated transaction. In some cases, promotion identifier 322 may be modified or reformatted before being transmitted to promotion processing engine 340.

Promotion processing engine 340 receives promotion identifier 322 and retrieves information about the associated promotion from database 350. Promotion processing engine 340 retrieves information from database 350 regarding whether promotion identifier 322 has already been redeemed a permitted number of times. For example, if promotion identifier 322 is only permitted to be used once, promotion processing engine 340 determines, based on information retrieved from database 350, whether promotion identifier 322 has been previously used in a transaction. If promotion identifier 322 is permitted to be used a total of five times, promotion processing engine 340 determines, based on information retrieved from database 350, whether promotion identifier 322 has already been used five time.

If promotion processing engine 340 determines that promotion identifier 322 is valid, promotion processing engine 340 retrieves or generates a discount code 324 for the transaction based on promotion identifier 322. However, discount code 324 is different than promotion identifier 322. Promotion identifier 322 will not trigger POS 330 to apply the discount. Discount code 324 is a protected or confidential code that is not made available to customer 310 or, in some cases, to employees of the merchant who may be operating POS 330. Discount code 324 causes POP 330 to apply a discount or other benefit based on the promotion with which promotion identifier 322 is associated.

After promotion processing engine 340 transmits discount code 324 to POS 330, discount code 324 is used by or causes POS 330 to apply the promotion to the transaction. A list of many different discount codes for many different promotions or discounts may exist. The list may be unique to a particular POS, a group of POSs, all POSs of a particular merchant, or some other grouping of systems. In addition to selecting discount code 324 based on promotion identifier 322, promotion processing engine 340 may also select discount code 324 based on information about POS 330. For example one discount code may cause POS 330 to apply a $20 credit associated with the promotion, but a different code may be required in order to direct a different POS system, or a different type of POS system, to apply the same $20 credit. In some cases, a merchant with multiple POS systems may configure its POS systems such that different discount codes are required to trigger the same discount at different systems. For example, the POSs of a merchant in one geographical location may be configured to use different discount codes that POSs of the same merchant in a different geographical location in order to further limit use of a particular discount.

In some cases, discount code 324 is transmitted directly to and processed by POS 330 without an operator of POS 330 having visibility to or access to discount code 324, or other discount codes. In this way, these techniques provide protection against the discount code getting into the hands of someone who may distribute or otherwise attempt to use the discount code in an inappropriate manner. In some cases, POS 330 may be configured such that it will only apply discount codes received from promotion processing engine 340, or a similar device or system. In this case, PS 330 would not apply discount code 324 if it was supplied directly by customer 310 or an operator of POS 330. In this way, a merchant that is an owner/operator of POS 330 can get further assurance that only discounts that have been validated by promotion processing engine 340, and/or similar systems, will be applied to transactions.

Promotion processing engine 340 may also perform additional validation steps to validate promotion identifier 322 provided by customer 310 or validate that promotion identifier 322 is applicable to the transaction being conducted by customer 310. Examples of these additional validation steps are discussed in detail below.

In one example, promotion identifier 322 is only applicable when certain products or services, or combinations of products and services, are included in the transaction. In addition to transmitting promotion identifier 322 to promotion processing engine 340, POS 330 may also transmit a list of all the products and/or services included in the transaction to promotion processing engine 340. In some cases, this information is transmitted in the form of stock-keeping units (SKUs). Use of other types of product/service identifiers is possible. Promotion processing engine 340 accesses database 350 to retrieve a set of rules or requirements associated with promotion identifier 322. This set of rules or requirements may include a list of the products or services required to satisfy the promotion. Using this information and the received information about the products or services included in the transaction, promotion processing engine 340 determines whether the requirements of the promotion have been satisfied.

For example, promotion identifier 322 may be associated with a credit of up to $20 toward a printing cartridge with the purchase of a qualifying printer. Customer 310 initiates a transaction though POS 330. It should be understood that initiating a transaction with a POS may include conducting an online transaction at a merchant website and/or electronically exchanging information with a computing device of a merchant in order to conduct a transaction. The SKUs associated with the items in customer 310's purchase are transmitted to promotion processing engine 340 along with promotion identifier 322. Promotion processing engine 340 retrieves the requirements of the promotion associated with promotion identifier 322 from database 350, or from another location such as from a server of a product manufacturer. For example, the promotion requirements may include a list of all of the printer SKUs eligible for the promotion and all of the associated printing cartridge SKUs that are eligible for the promotion. Promotion processing engine 340 determines if the SKU(s) received from POS 330 are on the list and satisfy the rules of the promotion. In some cases, a rule of the promotion may require one or more products from a category of products. Processing engine 340 may also make a determination about whether the product category requirement is satisfied based on the received SKUs.

In another example, a minimum purchase amount may be associated with a promotion. For example, a promotion may require that customer 310 make a $100 purchase to qualify for the promotion. In another example, a discount may apply if customer 310 purchases a particular type of product costing more than $40. In this case, POS 330 may also transmit prices of the products being purchased and/or a total amount for the transaction to promotion processing engine 340. Promotion processing engine 340 may use this information to determine if one or more purchase amount or product price requirements associated with the promotion are satisfied before transmitting discount code 324 to POS 330.

In another variation of validating promotion identifier 322, promotion processing engine 340 transmits information about the requirements of the promotion to POS 330. For example, after receiving promotion identifier 322, promotion processing engine 340 retrieves a list of products eligible for the promotion from database 350, or from another system. Promotion processing engine 340 transmits the list of eligible products and/or other requirements of the promotion to POS 330. POS 330 then uses this information to locally determine if the product and/or other requirements of the promotion are satisfied. Promotion processing engine 340 may transmit discount code 324 to POS 330 at the same time the requirements of the promotion are transmitted to POS 330 or may be configured to wait for a response from POS 330 indicating whether the promotion requirements are satisfied before transmitting discount code 324 to POS 330.

In yet another example of a promotion validation process, promotion processing engine 340 may determine whether a time requirement associated with the promotion is satisfied before transmitting discount code 324 to POS 330. As with other types of promotion information, the time requirement information may be retrieved from database 350 or from another system. A time requirement may include an expiration date after which a promotion is no longer valid, a window of time during which the promotion may be redeemed (i.e., any day between 9:00 AM and 11:30 AM), days of the week when the promotion may be redeemed (i.e., Tuesdays, Thursdays, and Sundays), a start date for the promotion (i.e., any time after March 1st), an excluded time period (i.e., not valid on holidays), or other time-based limitations, including combinations thereof.

In many cases, promotion processing engine 340 may be in a different geographical location than POS 330. In these cases, promotion processing engine 340 may make a determination regarding whether a time requirement is satisfied based on a local time associated with POS 330. For example, a promotion may be valid before noon on a given day. While it may be 11:15 AM at the location of POS 330, it may be 5:15 PM at the location of promotion processing engine 340. Promotion processing engine 340 may still validate promotion identifier in this situation because the time requirement (before noon) is satisfied at the location of POS 330. Promotion processing engine 340 may determine the local time of POS 330 based on information about a known physical location of POS 330 or may receive an indication of the current local time from POS 330 in conjunction with receiving promotion identifier 322. In another variation, customer 310 may be in a different physical location than POS 330. POS 330 may determine a local time based on a location of customer 310 and provide this information to promotion processing engine 340 such that any of the timing requirement determinations described in the examples above may be based on a local time for customer 310.

Because each instance of a promotion is associated with a unique identifier, individual rules may be established for each instance of the promotion and stored in database 350. For example, one instance of the promotion may have more lenient time requirements than another instance because a customer satisfied a higher eligibility or customer loyalty threshold. Many other examples of individual rules for promotions are possible. For example, one instance of a promotion may be configured such that a customer is required to purchase four of a specified item in order to get a 25% discount while another customer is only required to purchase three of the items to get the discount. These requirements for individual instances of a promotion, or subgroups of promotions, may be managed by associating the unique identifier associated with each of the instance of the promotion and with individual rules in database 350. In some cases, a promotion identifier may be associated with a set of general rules for the promotion as well as a set of specific rules that define that instance of the promotion.

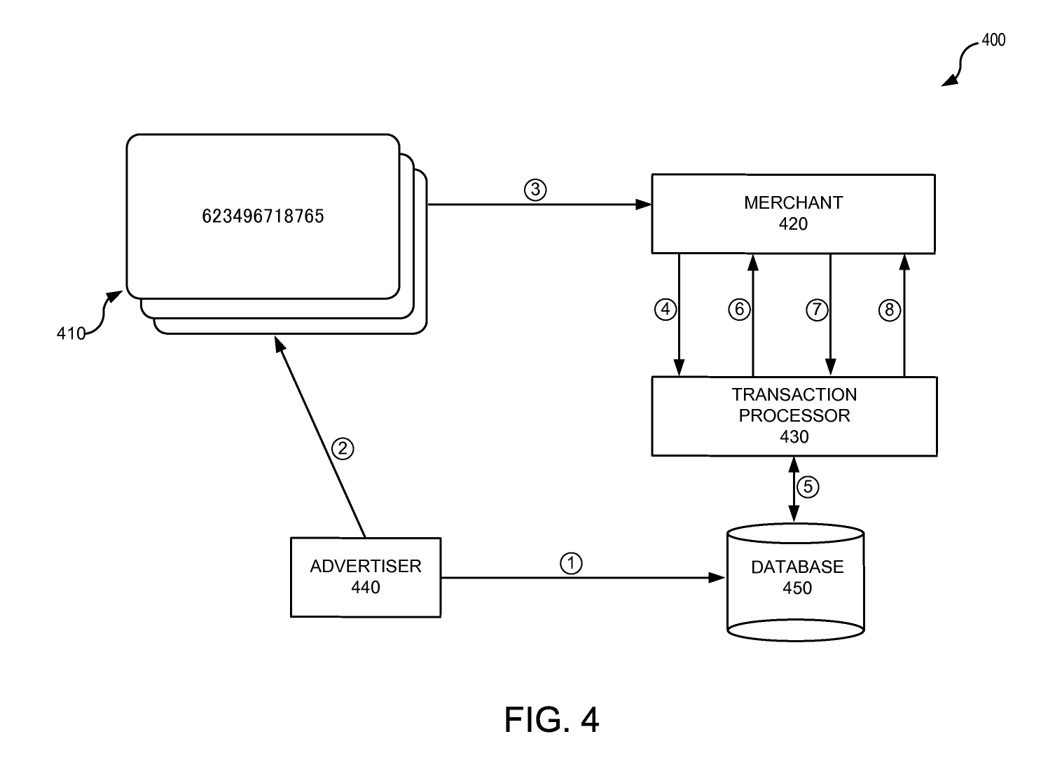

FIG. 4 illustrates method 400 of processing a promotion in accordance with some of the disclosed techniques. In method 400, advertiser 440 distributes promotional materials to customers or potential customers of merchant 420. The functions of advertiser 440 could also be performed by merchant 420, transaction processor 430, or another party. The promotions are distributed to customers in the form of account cards 410. A plurality of account cards 410 may be distributed to different customers. Account cards 410 each have unique numbers such that they can be distinguished from each other. Account cards 410 may have features similar to gift cards or prepaid cards and may be processed in similar ways, but have zero balances. In one example, the promotion is a discount of a specified percentage off of a specific product. The discount amounts associated with each of account cards 410 may be the same or may differ and be based on customer loyalty or some other factor. Account cards 410 each have a unique account number and are processed by transaction processor 430 using methods similar to those used for prepaid account cards or gift cards.

At step 1 of method 400, advertiser 440 stores promotion information associated with one or more of account cards 410 in database 432. The stored information may contain various pieces of information related to the promotion including: the card number/identifier, a promotion code, discount information, a validity period, a customer name, promotion rules, a product type, a product category, product identifiers, or other information. At step 2, advertiser 440 distributes account cards 410 to customers. This distribution may be through random mailings, customer satisfaction programs, loyalty programs, targeted marketing, customer-specific programs, or other marketing activities. At step 3, one or more customers who received an account card 410 attempt to redeem the account card at merchant 420 in a transaction. The transaction may be a transaction conducted in person or a transaction conducted using an electronic means of communication.

Account card 410, or the information on account card 410, is processed through a POS system of merchant 420. At step 4, transaction information including the number or other unique identifier of account card 410 is electronically transmitted to transaction processor 430. Additional transaction information may also be communicated to transaction processor 430 such as a SKU, other product identifying information, a product price, a transaction amount, a customer name, or other transaction related information. Based on the received account number, transaction processor 430 retrieves the promotion information associated with the identifier from database 432. Using the promotion information, transaction processor 430 validates the requested discount based on one or more of the following criteria: whether the account number is valid, whether the request is properly made within a time validity window, whether the request is associated with a customer the promotion was originally distributed to, whether the request is associated with a product allowed under the promotion, and/or whether other promotion conditions are satisfied.

At step 6, transaction processor 430 returns a response to merchant 420. If transaction processor 430 determines that the particular account number has already been redeemed or that some other condition of the promotion is not satisfied, the response may include a denial of the promotion request. For example, the customer may be attempting to redeem the promotion for a product which is not covered by the promotion. In some cases, the promotion may be valid only if redeemed within a specified time period or only if redeemed by a specified person. The product, product category, and any other conditions of the promotion, are validated based on a comparison of the information associated with the promotion stored in database 432 by advertiser 440 and the information about the requested transaction provided by merchant 420 at step 4.

If transaction processor 430 determines that the request is valid, the response at step 6 may include one or more of: an approval message, a discount code to be processed by merchant 420's POS system, a discount amount, a remaining balance, and/or an adjusted product price. Transaction amount adjustments or product price adjustments may occur at transaction processor 430 or at merchant 420. When the promotion is redeemed, database 432 may be updated to indicate that the particular account number involved has been used. If merchant 420 wishes to allow only one redemption for each account number, future requests will be denied based on the updated redemption information in database 432. During the redemption process, the customer is not in possession of the discount that actually triggers the merchant's POS system to provide or apply the discount.

In some cases, after a discount has been applied to a transaction, no further amount may be due and the transaction is complete. In other cases, the remaining amount due may optionally be paid using a credit card, debit card, gift card, or prepaid card which is optionally processed in steps 7 and 8. Transaction processor 430 may be an entity that is also capable of processing payments using one of these card or payment account types. The combination of the promotion card and one or more of these other forms of payment may be processed using one or more split tender redemption processes known in the field.

In a variation of method 400, a particular instance of a promotion may only be redeemed by a designated customer. Advertiser 440, or another entity, may associate the unique identifier for the promotion with one or more payment accounts of the customer in database 450. Steps 4-8 of method 400 may be modified such that the customer's payment account information (i.e., credit or debit card account number) is provided in conjunction with the unique identifier of the promotion. In this way, transaction processor 430 can determine if the customer attempting to redeem the promotion is the customer to which that instance of the promotion was awarded or assigned. In this way, a merchant or advertiser can control not only how many times a particular instance of a promotion is redeemed, but also who is redeeming the promotion. In some cases, redemption rights for a promotion may also be extended to a controlled group of other individuals such as family members, employees of a company, or another group.

In another variation of method 400, the customer retains card 410 or the associated identifier after redemption for future uses. In this case, merchant 420 may wish to provide another promotion, discount, or offer to the customer at some future time. Although account card 410 may not be valid for use for another promotion immediately after its initial use, information associated with a new promotion may be subsequently loaded into database 450 and the customer notified of the new promotion opportunity. Because each identifier is unique, or controlled to a limited number of instances, merchant 420 can make this new offer again knowing that it cannot be easily duplicated or widely distributed. In addition, because the account number may be associated with a specific customer, merchant 420 can monitor buying behaviors, response to promotions, and other useful strategic and targeted marketing business information.

In another variation of method 400, the unique identifier associated with the promotion is a credit or debit card number already used by the customer. For example, a customer who has previously shopped at merchant 420 using a credit card may be notified of a promotional offer. The information associated with the promotion is associated with the customer's credit card number in database 450 rather than creating a new identifier or account number. In order to redeem the offer, the customer has to provide only their credit/debit account number with which the offer has been associated. Beneficially, the customer does not have to provide a separate coupon, promotion card, or promotion code. When the credit card is processed for the transaction and sent to transaction processor 430, information about the promotion is retrieved from database 450 as described in previous examples. However, in this case, the information is associated with and retrieved based on the credit/debit account number which existed before the promotion was offered. This method of promotion redemption may require that the customer provide an indication that he or she is aware of the promotion when conducting the transaction or may occur automatically when the credit/debit account is processed.

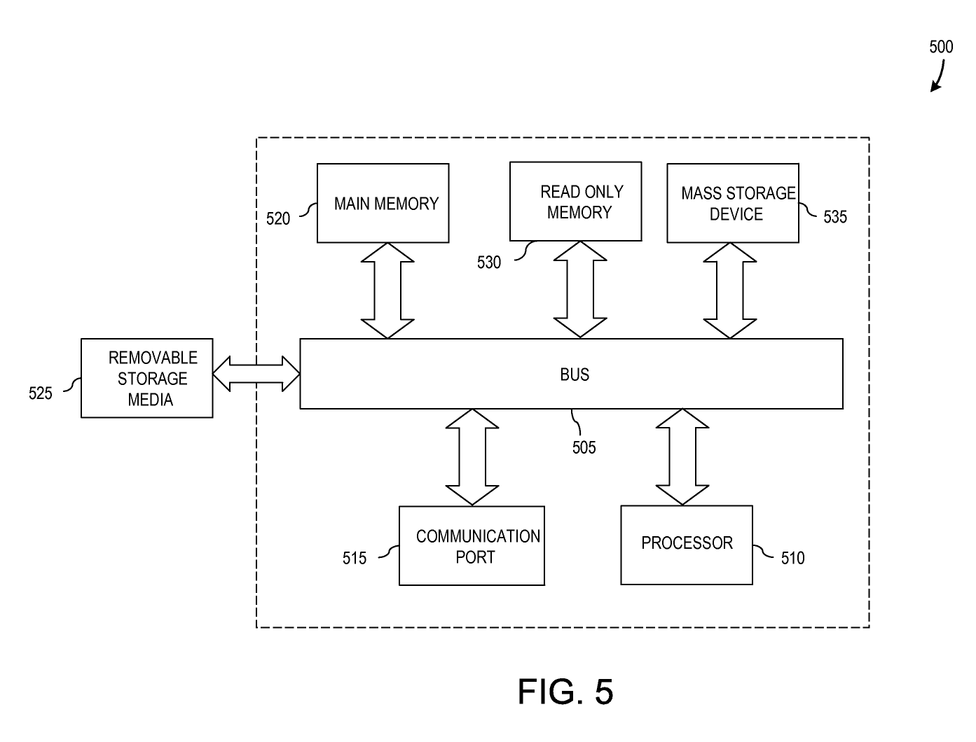

FIG. 5 illustrates computer system 500 for processing promotions. Computer system 500 includes a bus 505, at least one processor 510, at least one communication port 515, a main memory 520, a removable storage media 525, a read only memory 530, and a mass storage device 535.

Processor 510 can be any known microprocessor, computer processor, central processing unit (CPU), programmable logic, or other computing device, including combinations thereof. Communication port 515 may be any type of port for communicating over one or more networks such as a Local Area Network (LAN), a Wide Area Network (WAN), the Internet, or any network to which the computer system 500 connects.

Main memory 520 can be Random Access Memory (RAM), or any other dynamic storage device(s) commonly known in the art. Read only memory 530 can be any static storage device(s) such as flash memory, Programmable Read Only Memory (PROM) chips, or other devices for storing static information such as computer-executable instructions for processor 510. Mass storage device 535 can be used to store information and instructions. For example, mass storage device 535 may include a hard disk, an optical disc, a tape drive, an array of disks in a redundant array of independent disks (RAID) configuration, or a network storage system. Removable storage media 525 can be any type of memory card, external hard drive, floppy drive, Compact Disc Read Only Memory (CD-ROM), Re-Writable Compact Disc (CD-RW), Digital Video Disk Read Only Memory (DVD-ROM), including combinations thereof. Bus 505 communicatively couples the elements of computer system 500.

Computer system 500 may be configured to process promotions in accordance with any of the techniques disclosed herein. The components of computer system 500 are described above in order to describe possible configurations. However, in no way should the aforementioned examples limit the scope of the invention, as they are only exemplary embodiments.

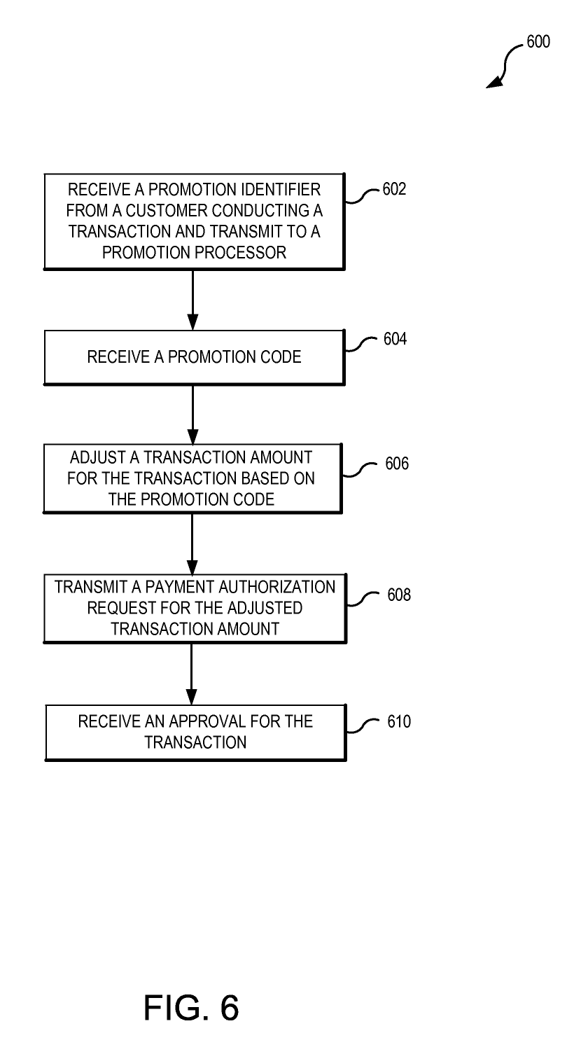

FIG. 6 illustrates method 600 of processing a promotion at a merchant in accordance with some of the disclosed techniques. Method 600 is described with respect to operating environment 300 of FIG. 3. However, implementation in other operating environments, such as operating environment 100 of FIG. 1, is possible.

At step 602 of method 600, POS 330 receives a promotion identifier from a customer conducting a transaction and transmits the promotion identifier to a promotion processor operating a promotion processing system such as promotion processing engine 340. The promotion identifier may be received directly from the customer, received from an electronic device of the customer, or received from the customer via a merchant or an employee of the merchant.

If the promotion identifier from the customer is validated, POS 330 receives a promotion code from promotion processing engine 340 (step 604). POS 330 then adjusts a transaction amount for the transaction based on the promotion code (step 606). If the promotion covers the full cost of the transaction, no further steps may be necessary. If a non-zero transaction amount remains, the customer may pay the remaining amount using cash or a check. Alternately, the customer may pay the remaining balance using a credit card, a debit card, a gift card, or a prepaid card. In this case, POS 330 then transmits a transaction authorization request to a transaction processing system for the remaining amount (step 608). The transaction processing system may be promotion processing engine 340 or may be a different processing system, including a different processing system operated by the same entity that operates promotion processing engine 340. After the transaction request is authorized, POS 330 receives an approval notification for the transaction (step 610).

In some cases a promotion may have a potential benefit or credit balance which is greater than the value of the product or service purchased. For example, an account promotion may be valid for a free dessert at a restaurant up to $10. When the promotion identifier and transaction information is transmitted to promotion processing engine 340, the product information is validated to make sure it belongs to the correct category. For instance, verifying that there is a dessert on the bill. In addition, promotion processing engine 340 compares the price of the product to the promotion information. The total purchase may be for $75 and include multiple meals, but the most expensive dessert may only be $7. In this case, the promotion processing engine 340 adjusts the discount or promotion amount by $7 based on the promotion and the product category and price information provided by the merchant.

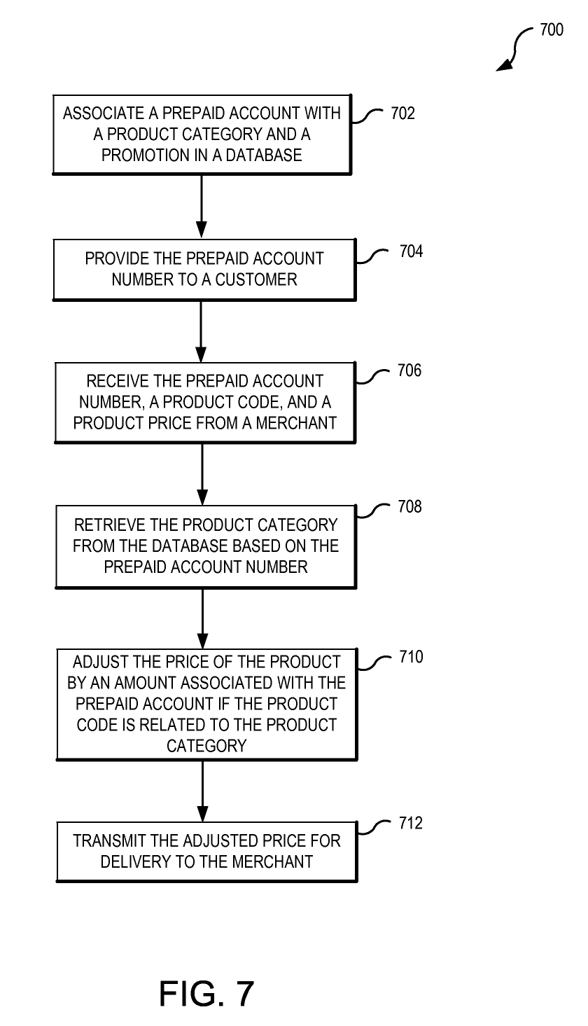

FIG. 7 illustrates method 700 of processing a promotion using a prepaid account. Method 700 is described with respect to operating environment 100 of FIG. 1 although method 700 may be implemented in other operating environments or systems.

Merchant 120 desires to provide a promotion to one or more customers in the form of a prepaid account which has a particular balance to be used only toward a particular product, service, category of product, or category or service. The promotion may also be designed to include other requirements such as a minimum purchase amount or a specified validity period. A prepaid account is created and associated with the promotion in database 132 along with a product category associated with the promotion and, in some cases, other requirements of the promotion (step 702). The prepaid account number is then provided to customer 110 (step 704). This may occur through direct communication with customer 110 or through one or more other entities such as promotion distributor 140.

In one example, merchant 120 may be a retailer wishing to provide one or more customers a prepaid card which has a balance of $40 to be used toward purchase of a digital camera. The retailer wishes to make sure that the customer uses the prepaid card toward the purchase of a camera and not simply redeem the card for a less expensive item. The retailer may also wish to issue a limit number of these promotions such that the promotion code cannot be duplicated and used by an unlimited number of customers. It should be understood that many other types of promotions are possible. When customer 110 provides the prepaid account number or card to merchant 120 as part of a transaction, merchant 120 transfers the account number to transaction processor 130 along with a product code for the selected product and a price of the product (step 706).

Based on the account number, the product category associated with the promotion, which was stored at step 702, is retrieved from database 132 (step 708). If the product code received from merchant 120 matches, or is otherwise acceptably related, to the product category received from database 132, funds associated with the prepaid account are applied to the transaction and the price of the product is adjusted based on the terms of the promotion (step 710). Then, the adjusted price is transmitted for delivery to merchant 120 (step 712). Alternatively, the information may be transmitted to merchant 120 and the price adjustment may occur at merchant 120, or some other location. Beneficially, merchant 120 is assured that the prepaid account can only be used by the customer for the selected category of products without having to rely on employees or their own systems to perform this screening process. If a match or positive relationship between the product code and the stored product information is not determined, the price is not adjusted.

The components described above are meant to exemplify some types of possibilities. In no way should the aforementioned examples limit the scope of the invention, as they are only exemplary embodiments.

Embodiments of the present invention include various steps and operations, which have been described above. A variety of these steps and operations may be performed by hardware components or may be embodied in non-transitory machine-executable instructions, which may be used to cause a general-purpose or special-purpose processor programmed with or executing the instructions to perform the steps. Alternatively, the steps may be performed by a combination of hardware, software, and/or firmware.

While, for convenience, embodiments of the present invention are described with reference to credit card transaction processing, embodiments of the present invention are equally applicable to various other systems and processes for processing financial transactions.

Also, for the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

The present invention provides promotion processing features. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

### TERMINOLOGY

Brief definitions of terms, abbreviations, and phrases used throughout this application are given below.

The terms ‘payment processor’ and ‘transaction processor’ are used herein to describe any entity that handles processing of credit cards, debit cards, prepaid cards, or electronic payments of various types on behalf of merchants, merchant banks, and/or customers and may include a front-end processor, a back-end processor, or both. The terms may be used interchangeably and any discussion of one may apply equally to the other. Similarly, the terms ‘payment processing system’ and ‘transaction processing system’ may be used interchangeably and any description or discussion of one may apply equally to the others.

The term ‘customer’ refers to any entity using one of the forms of payment described above to perform a transaction. A customer may be an individual, a company, a government, or any other entity desiring to conduct a financial transaction.

The terms ‘account,’ ‘customer account,’ and ‘payment account’ are used herein to describe any type of account a customer may use to provide payment for a transaction including a credit card account, a debit card account, a prepaid account, a bank account, a mobile wallet, or an account of another type that can be used to make electronic payments.

The terms ‘promotion,’ ‘offer,’ and ‘discount’ are used herein to describe any marketing method, element, or tool used to encourage or entice a customer to purchase a product or service or enter a transaction in some other way. These terms are used interchangeably herein and any description or discussion of one may apply equally to the others. The terms ‘redeem’ or ‘redemption’ may refer to any of promotions, offers, or discounts.

The terms ‘promoter,’ ‘advertiser,’ ‘promotion provider,’ ‘promotion marketer,’ ‘promotion publisher,’ and ‘promotion publisher’ are used herein to describe the various entities and functions associated with marketing, providing, and processing of promotions, offers, and discounts. These terms may describe separate entities and functions. However, one or more entities may perform any combination of these functions. In some cases, these functions may also be performed by a merchant, a payment processor, or a transaction processor.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “in one example,” “in some examples,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

What is claimed is:

1. A computer-implemented method of processing a promotion comprising:
associating a plurality of unique identifiers with the promotion in a database;
receiving, at a computer, at least one of the unique identifiers from a merchant system operated by a merchant, wherein the at least one unique identifier was provided by a customer to the merchant in order to redeem the promotion in a transaction;
retrieving promotion information from the database by the computer based on the received unique identifier;
validating the received unique identifier by the computer; and
transmitting a transaction instruction from the computer for delivery to the merchant system.

2. The method of claim 1 wherein the merchant system is a point of sale system.

3. The method of claim 2 wherein the transaction instruction includes a discount code used by the point of sale system to adjust an amount of the transaction.

4. The method of claim 1 further comprising documenting usage of the received unique identifier in the database.

5. The method of claim 4 wherein validating the received unique identifier includes determining, based on the database, that the received unique identifier has not already been used a maximum permitted number of times.

6. The method of claim 1 further comprising receiving transaction information identifying a product or a service included in the transaction and wherein validating the received unique identifier includes determining, based on the received transaction information and the retrieved promotion information, that the product or the service satisfies a requirement of the promotion.

7. The method of claim 6 wherein:
the transaction information identifying the product or the service includes a stock-keeping unit (SKU) of the product or the service; and
determining that the product or the service satisfies the requirement of the promotion includes determining that the SKU is included in a list of acceptable SKUs for the promotion.

8. The method of claim 1 wherein validating the received unique identifier includes:
transmitting a product requirement associated with the promotion to the merchant system; and
receiving an indication from the merchant system that the product requirement is satisfied.

9. The method of claim 8 wherein the product requirement includes one or more product SKUs that will satisfy the promotion.

10. The method of claim 1 wherein validating the received unique identifier includes determining that a time requirement associated with the promotion is satisfied.

11. The method of claim 10 wherein the time requirement includes one or more of: an expiration date of the promotion, a window of time in which the promotion is valid, or one or more days of the week in which the promotion is valid.

12. The method of claim 10 wherein determining that the time requirement associated with the promotion is satisfied includes using a current time associated with a location of the merchant system.

13. The method of claim 1 further comprising receiving a customer identifier associated with the customer and wherein validating the received unique identifier includes determining, using the customer identifier, that the customer is eligible to redeem the promotion.

14. The method of claim 13 wherein the customer identifier is an identifier of an account used by the customer to pay for the transaction.

15. The method of claim 1 wherein the unique identifier is a prepaid account identifier.

16. A system for processing promotions comprising:
a database;
a memory containing computer-readable instructions;
a processor that executes the instructions, wherein executing the instructions configures the processor to:
associate a unique identifier with a promotion in the database;
receive the unique identifier from a merchant system operated by a merchant, wherein the unique identifier was provided by a customer to the merchant in order to redeem the promotion in a transaction;
retrieve promotion information from the database in response to receiving the unique identifier;
validate the unique identifier; and
transmit a transaction instruction for delivery to the merchant system.

17. The system of claim 16 wherein the merchant system is a point of sale system.

18. The system of claim 16 wherein the transaction instruction includes a transaction adjustment code used by the merchant system to adjust an amount of the transaction.

19. The system of claim 16 wherein executing the instructions further configures the processor to document usage of the received unique identifier in the database.

20. The system of claim 19 wherein to validate the unique identifier includes to determine that the received unique identifier has not already been used to redeem the promotion.

21. The system of claim 16 wherein executing the instructions further configures the processor to receive transaction information identifying a product or a service included in the transaction and wherein to validate the unique identifier includes to determine, based on the received transaction information and the retrieved promotion information, that the product or the service satisfies a requirement of the promotion.

22. The system of claim 16 wherein to validate the unique identifier includes to:
transmit a list of acceptable products associated with the promotion to the merchant system; and
receive an indication from the merchant system that the transaction includes a product on the list of acceptable products.

23. The system of claim 16 wherein to validate the unique identifier includes to determine that the transaction is occurring during a window of time in which the promotion is valid.

24. The system of claim 16 wherein to validate the unique identifier includes to determine that the transaction is occurring on a day on which the promotion is valid.

25. The system of claim 16 wherein to validate the unique identifier includes to determine a time requirement of the promotion is satisfied based on a current time associated with a location of the merchant system.

26. The system of claim 16 wherein the executing the instructions further configures the processor to receive a customer identifier associated with the customer and wherein to validate the received unique identifier includes to determine, using the customer identifier, that the customer is eligible to redeem the promotion.

27. The system of claim 26 wherein the customer identifier is an identifier of an account used by the customer to pay for the transaction.

28. A non-transitory computer-readable medium including computer-executable instructions that, when executed by at least one computer processor, direct the at least one computer processor to:
associate a unique identifier with a promotion in a database;
receive the unique identifier from a merchant system operated by a merchant in conjunction with a transaction in which a customer provided the unique identifier to redeem the promotion in a transaction;
retrieve promotion information from the database in response to receiving the unique identifier and based on the unique identifier;
validate the unique identifier; and
transmit a transaction instruction for delivery to the merchant system.
